(19) United States
(12) Patent Application Publication
(10) Pub. No.: US 2026/0147778 A1
(43) Pub. Date: May 28, 2026

(54) ETL JOB OPTIMIZER

(71) Applicants: American Express Travel Related Services Company, Inc., New York, NY (US); American Express (India) Private Limited, Gurgaon (IN)

(72) Inventors: Deeksha Sikarwar, Gurugram (IN); Mayank Singh, Ghaziabad (IN); Phanikalyan Cherukuri, Chandler, AZ (US); Ritesh Kumar Bansal, Gurgaon (IN); Ashok Kumar Nair, Phoenix, AZ (US); Ajeet Kumar Pandey, Gurgaon (IN); Krish Lohia, Raniganj (IN)

(21) Appl. No.: 18/961,951

(22) Filed: Nov. 27, 2024

(51) Int. Cl. G06F 16/25; G06F 16/2455

(52) U.S. Cl. CPC G06F 16/254; G06F 16/2456

(57) ABSTRACT

The present disclosure presents systems and related methods for optimizing extraction, transformation, and loading (ETL) operations. One such method comprises receiving an extraction, transformation, and loading (ETL) job that is in current deployment on an ETL job database; obtaining ETL job metadata for the extracted ETL job; obtaining database schema for input data sources in the ETL job; using the database schema, parsing the ETL job to identify structural components of the ETL job; providing, in a graphical user interface display, one or more recommendations to perform one or more optimization actions for at least one structural component of the ETL job; and/or performing the one or more optimization actions for the at least one structural component of the ETL job.

### BACKGROUND

Large data sets may exist in various levels of size and organization. With big data comprising data sets as large as ever, the volume of data collected incident to the increased popularity of online and electronic transactions continues to grow. For example, billions of records (also referred to as rows) and hundreds of thousands of columns worth of data may populate a single table. The large volume of data may be collected in a raw, unstructured, and undescriptive format in some instances.

Accordingly, in today's dynamic business landscape, where timely insights are crucial for informed decision making, optimizing data extraction, transformation, and loading (ETL) jobs becomes imperative due to these large data sets. However, a lack of optimization becomes evident in prolonged execution times of ETL jobs, delays in data availability, more resource consumption, and incurring higher costs. Thus, there is a need for optimized ETL processes to ensure that data is processed swiftly and accurately, enabling organizations to derive actionable insights promptly and maintain a competitive edge.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of an exemplary framework for an extraction, transformation, and loading (ETL) process in accordance with various embodiments of the present disclosure.

FIG. 2 is a block diagram showing components of an exemplary ETL job optimizer tool in accordance with various embodiments of the present disclosure.

FIG. 3 is a block diagram showing an overall ETL system in accordance with various embodiments of the present disclosure.

FIG. 4 is a flowchart diagram showing an exemplary ETL job optimizer method in accordance with various embodiments of the present disclosure.

FIGS. 5-8 depict exemplary graphical user interfaces in accordance with an aspects of the present disclosure.

### DETAILED DESCRIPTION

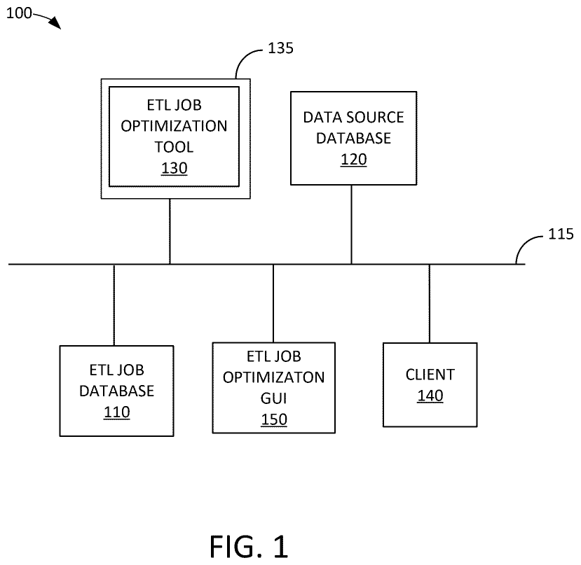

The present disclosure presents improved extraction, transformation, and loading (ETL) technologies that deliver shorter execution times and resource consumption as compared to conventional processes. As such, the present disclosure provides systems, methods, and computer program products for improving ETL job queries applied to big data sets. As used herein, big data may refer to partially or fully structured, semi-structured, or unstructured data sets including hundreds of thousands of columns and records. A big data set may be compiled, for example, from a history of purchase transactions over time, from web registrations, from social media, from records of charge (ROC), from summaries of charges (SOC), from internal data, and/or from other suitable sources. Accordingly, systems and methods of the present disclosure utilize an ETL job optimizer tool that is configured to scan one or more ETL jobs that are maintained in a network database and detect aspects of the ETL jobs (such as database queries), based on their structure or the structure of the underlying data records/tables, that can be optimized, corrected, or streamlined to improve performance of the ETL job during its execution by an ETL server (e.g., ETL server 135 in FIG. 1).

Referring now to FIG. 1, a framework 100 of an exemplary ETL process of the present disclosure is presented. Here, a database 110 of ETL jobs (ETL job database) is maintained on a computer network 115 along with a database of data source (data source database) 120, where the ETL job database 110 provides details (e.g., metadata) on one or more database queries that the ETL job is configured to perform and the data source database 120 provides details (e.g., metadata) on tables or other input data sources (e.g., a table is clustered, partitioned, etc.) that are referenced in an ETL job. In general, ETL jobs perform batch processing of data from one or more data sources to one or more target destinations. For example, an ETL job may be scheduled to run at the end of each day that reads transaction data from multiple transaction databases, processes the transaction information into a common format, and stores the transaction information in a target database or data warehouse.

In various embodiments, ETL job metadata can store details on the ETL jobs that are maintained in the ETL job database 110 (such as ETL job names, ETL job purposes, name and locations of tables and files from which data is being sourced by a particular ETL job, names and locations of tables and files to which data is being transformed by a particular ETL job, jobs or script name on which a particular ETL job is dependent, jobs or script name that should be run after the particular job is completed, timing or schedule information on how often a particular job should be executed, etc.).

Correspondingly, an ETL job optimizer tool 130 (via an ETL server computer 135) scans an ETL job in the ETL job database 110 and the corresponding data source metadata in the data source database 120 to detect opportunities for optimizing the ETL job to improve the structure of the ETL job (e.g., JavaScript Object Notation (JSON) representation of ETL Job) and underlying queries enabling improved performance of an ETL server 135 that executes the ETL job on a network database of source tables/records. For example, an unoptimized ETL job may complete execution in 10 hours, where an optimized ETL job may complete execution in 2 hours, which improves performance of the ETL server 135, especially when a series of ETL jobs that depend upon one another can be optimized individually, resulting in a compounding of improvements to the ETL server overall.

As a non-limiting example, a user's client computer or device 140 may request the ETL job optimizer tool 130 to scan the ETL job database 110 for a list of current ETL jobs and be provided a graphical user interface display 150 showing the list of current ETL jobs along with an option (e.g., selectable button or checkbox) to execute the ETL job optimization tool 130 and perform optimization(s)/improvement(s) to the list of ETL jobs.

As non-limiting examples, improvements made on an ETL job can involve database queries and can be related to issues involving unused columns, join patterns, unnecessary decryption operations, clustering columns usage, partition column usage, or other structures and/or components of an ETL job (e.g., database query) that are not being effectively stated to achieve a particular purpose. Accordingly, in various embodiments, the ETL job optimizer tool 130 presents a graphical user interface display 150 that delineates the aspects of the ETL job that can be optimized or improved and details on how the ETL job can be modified to result in the improvement (e.g., a “Filter Action does not contain a condition for table xxxx_yyyy_recogn, which is partitioned on zzzz_month.”). In various embodiments, the graphical user interface display 150 can also provide an option (e.g., selectable button or checkbox) next to each suggested modification approve/authorize the ETL job optimizer tool 130 to carry out the proposed modification. Alternatively, or in addition to, some embodiments of the graphical user interface display can provide an option (e.g., selectable button or checkbox) to authorize the ETL job optimizer tool 130 to carry out ALL the proposed modifications to the ETL job being assessed by the ETL job optimizer tool.

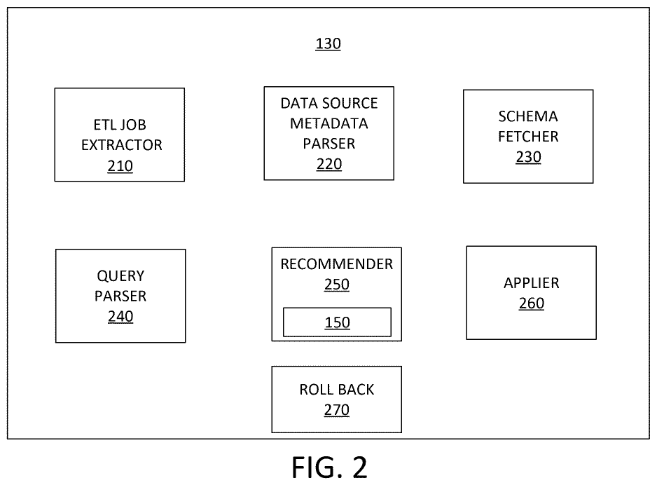

Referring now to FIG. 2 and in accordance with various embodiments, an ETL job optimizer tool 130 is a software and/or hardware module that has a plurality of components that enable the scanning and optimization of ETL jobs within a computer network 115. Accordingly, in various embodiments, the ETL job optimizer tool includes one or more of the following components. A job extractor component 210 is designed to extract an ETL job and its ETL job metadata from an ETL job database 110. Accordingly, the job extractor component 210 can request the names of ETL jobs and related details (e.g., version and project details, table names or other data source identifications, etc.) that are in current deployment by an ETL server 135. A data source metadata parser component 220 of the ETL job optimizer 130 may then be configured to obtain a data source using the provided information for a particular ETL job (e.g., table names referenced in an ETL job) and parse the data source to obtain details/metadata on the input tables/sources used in the ETL job from the data source database 120. For example, the ETL job metadata for a particular job may contain information related to the input (source) tables used in the ETL job, the transformation nodes or the intermediate nodes used in the ETL job, the join nodes used, the filters used, the output table that is to be created, etc. Accordingly, the data source metadata parser component 220 can extract the data source metadata using the ETL job name and other details (e.g., version number) provided by the job extractor component 210. From the data source metadata, a schema fetcher component 230 of the ETL job optimizer tool 130 can obtain database schema and additional metadata on the nodes and database tables that are referenced in the data source metadata obtained by the data source metadata parser component 220. For example, the schema and metadata information can indicate how/if the input tables are partitioned, clustered, or generally organized, etc.

To illustrate, partitioning and clustering are two ways of organizing data within database tables into multiple segments. As background, a partitioned table is divided into segments, called partitions, that make it easier to manage and query table data. By dividing a large table into smaller partitions, query performance and control costs can be improved by reducing the number of bytes read by a query. Tables are partitioned by specifying a partition column which is used to segment the table. If a query uses a qualifying filter on the value of the partitioning column, an ETL server can scan the partitions that match the filter and skip the remaining partitions. As such, if data related to various countries is present in a table and the table is partitioned on a country code, the data for each country will be stored as a separate segment. Upon running a query that includes the country code for a particular country, such as China (e.g. contains a where clause specifying the country code for China), only the China data segment will be scanned instead of the complete table. On the other hand, if a query is executed and does not specify a country code, then the complete table will be scanned, which may be unnecessary and not optimal.

Correspondingly, a clustering of a database table organizes the table in a sorted manner. For example, if a set of data related to various countries is stored in a database table and the table is clustered based on the individual countries, all the data related to China will be grouped together in the table and all the data related to the United States will be grouped together in the table, and so forth. So, if an ETL job query applies a filter for a particular country (e.g., country code), an ETL server 135 can advantageously scan the group of data related to that country in the input/source database table (without needing to scan the whole database table).

With the extracted ETL job, a query parser component 240 of the ETL job optimizer tool 130 can parse an ETL job query (that makes up the ETL job) and identify its structural features. In various embodiments, the query parser component 240 can parse the ETL job into a tree like or hierarchal structure with connected structural elements comprising individual tables (e.g., partitioned tables, clustered tables, non-partitioned and/or clustered tables, etc.) and their connected nodes indicating the functions to be applied to such tables. Thus, the hierarchal structure may indicate that a query has a clustered/artitioned table and a cast or function being applied to the clustered/partitioned column. However, when a casting or functions are applied to a clustered/partitioned column, data for the whole table is going to be scanned and not just for a partition or cluster, which may not be optimal. Thus, by examining the hierarchal structure built by the query parser component 240 and data source metadata on the input data sources provided in this hierarchal structure, a recommender component 250 of the ETL job optimizer tool 130 can compile and recommend optimization actions to a user in a graphical user interface display 150. Accordingly, in various embodiments, the graphical user interface display 150 contains a list of recommended optimization actions along with an option (e.g., button or checkbox) for a user to authorize all or individual ones of the recommended optimization actions to be performed by an applier component 260 of the ETL job optimizer tool 130.

In various embodiments, to compile the list of optimization actions, the recommender component 250 performs a series of examinations to determine if the hierarchal structure contains particular issues that may need optimization or correcting. For example, in certain embodiments, partitioned tables are checked to determine if (a) subject queries of the ETL job are being applied correctly against any partitioned tables; (b) subject queries of the ETL job are being applied correctly against any clustered tables; (c) decryption operations are not being applied against NULL values; (d) encryption operations are not being applied against NULL values; (e) join operations involving tables are being applied in the correct order or sequence; and/or (f) any unused columns are identified/selected that are not being used; among others.

Any of the foregoing examinations may involve multiple steps. For example, in considering the correct applications of partitioned tables, the correct usage of “where clauses” in a query may be checked in addition to the correct usage of “casting functions.” Such examinations may be specified as types of rules that are performed by the recommender component 250. In various embodiments, the recommender component 250 may utilize a machine-learning or artificial intelligence (Al) network to learn one or more rules for optimizing the ETL jobs based on training on feedback provided from optimization actions performed by the applier component 260.

Accordingly, after receiving authorization, the applier component 260 modifies the ETL job query in accordance with the selected optimization actions and replaces the unoptimized ETL job query in the ETL job database 110 with the optimized ETL job query and publishes the optimized ETL job so that the ETL job can be executed by an ETL server 135.

In various embodiments, the ETL job optimizer tool 130 may also include a roll back component 270, such that any optimization actions corresponding to modifications made by the applier component 260 can be undone or “rolled back” to a previous state that existed in the original unoptimized ETL job. Accordingly, for such embodiments, metadata is saved on the changes made by the applier component 260 for selected optimization actions that can be referenced by the roll back component 270 to restore an ETL job or a portion of an ETL job to a previous state.

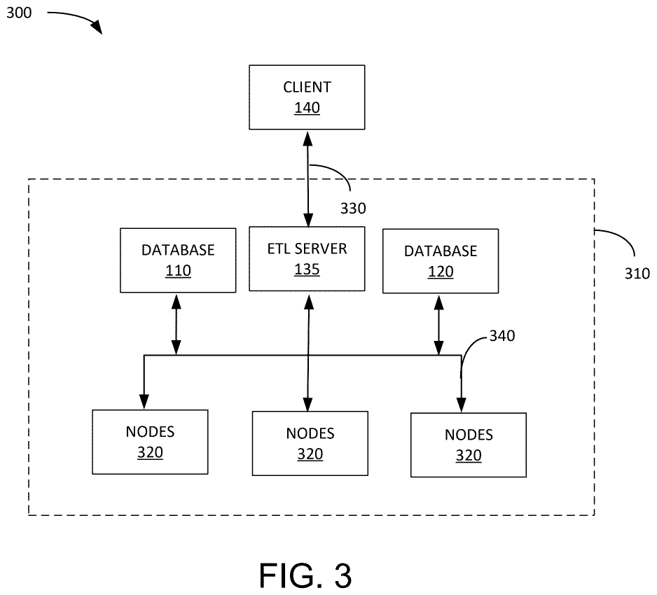

With reference to FIG. 3, a data extraction, transformation, and loading (ETL) system 300 is shown, in accordance with various embodiments. ETL system 300 comprises a distributed computing cluster 310 configured for parallel processing and storage. Distributed computing cluster 310 may comprise a plurality of nodes (computing devices) 320 in electronic communication with each of the other nodes as well as ETL server node 306 (or computing device). Processing tasks may be split among the nodes of distributed computing cluster 310 to improve throughput and enhance storage capacity. Distributed computing cluster may be, for example, a Hadoop® cluster configured to process and store big data sets in database(s) 110 with some of nodes 104 comprising a distributed file system and some of nodes 320 comprising a distributed processing system. In that regard, distributed computing cluster 310 and ETL framework 100 may be configured to support a Hadoop® cluster version 2.7.1 or earlier as specified by the Apache Software Foundation at http://hadoop.apache.org/docs/.

In various embodiments, nodes 320, ETL server 135, and client device 140 may comprise any devices capable of receiving and/or processing an electronic message via network 330 and/or network 340. For example, nodes 104 may take the form of a computer or processor, or a set of computers/processors, such as a system of rack-mounted servers. However, other types of computing units or systems may be used, including laptops, notebooks, hand held computers, personal digital assistants, cellular phones, smart phones (e.g., iPhone®, Samsung®, Android®, etc.) tablets, wearables (e.g., smart watches and smart glasses), or any other device capable of receiving data over the network.

In various embodiments, client device 140 may submit requests to ETL server 135. ETL server 135 may distribute the tasks among nodes 104 for processing to complete the job intelligently. Client device 140 may be a separate machine from distributed computing cluster 310 in electronic communication with distributed computing cluster 310 via network 330. A network may be any suitable electronic link capable of carrying communication between two or more computing devices. For example, network 330 may be an internal TCP/IP network or an external network connection over the Internet. Nodes 320 and ETL server 135 may similarly be in communication with one another over network 340. Network 340 may be an internal network isolated from the Internet and client device 140, or, network 340 may comprise an external connection to enable direct electronic communication with client device 140 and the internet.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptography systems.

In various embodiments, ETL system 300 may process hundreds of thousands of records from a single data source. ETL system 300 may also ingest data from hundreds of data sources, such as data source database 120. Nodes 320 may process the data in parallel to expedite the processing. Furthermore, the transformation and intake of data as disclosed below may be carried out in memory on nodes 320. For example, in response to receiving an input/source data file of 100,000 records, a system with 100 nodes 320 may distribute the task of processing 1,000 records to each node 320. Each node 320 may then process the stream of 1,000 records while maintaining the resultant data in memory until the batch is complete. The results may be written, augmented, logged, and written to disk for subsequent retrieval.

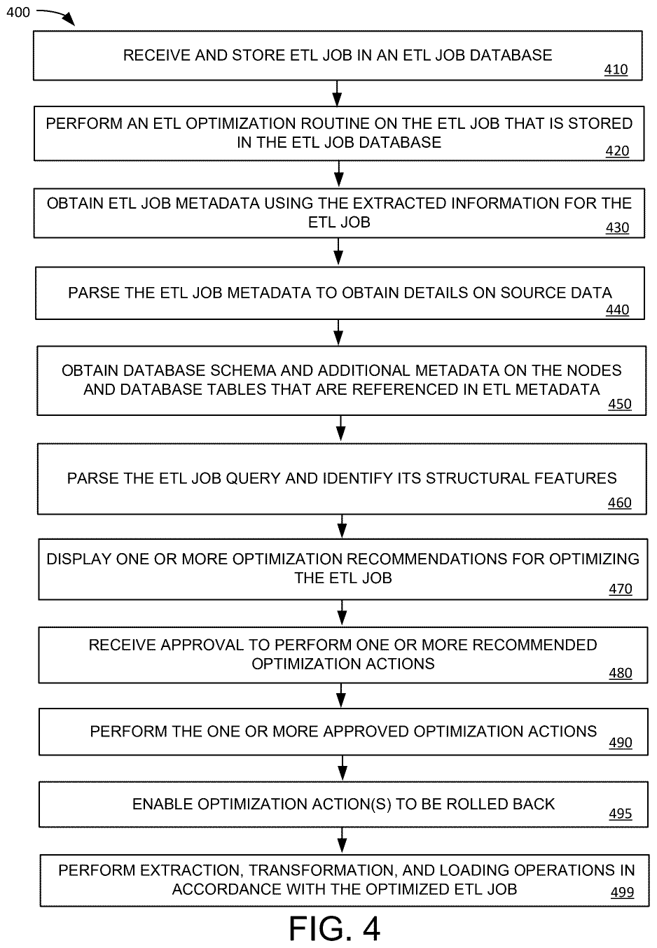

With reference to FIG. 4, an extraction, transformation, and loading (ETL) job optimizer method 400 using system 300 is shown, in accordance with various embodiments. Method 400 can begin by an ETL server 135 receiving an ETL job from a client device 140, in Block 410, in which the ETL server 135 can store the ETL job in an ETL job database 110. In general, ETL jobs are designed to extract data from one or more database or non-database systems, transform the data that is extracted into a desired format, and load the transformed data to one or more database or non-database systems. The term “database tables” is used herein to represent database tables and non-database data that may be “mapped” to “sets of rows.” For example, a Comma Separated Values (CSV) file may be mapped to a table, where each comma separated field in a line in the CSV file is mapped to a table column value, and the whole line is mapped to a row in the mapped table.

Subsequently, the ETL server 135 can perform an ETL optimization routine on the ETL job that is stored in the ETL job database 110, in Block 420. In various embodiments, the ETL optimization routine can be performed by an ETL job optimizer tool 130 executed by the ETL server 135. Thus, in various embodiments, a job extractor component 210 of the ETL job optimizer tool 130 can be designed to extract the names of ETL jobs and related details (e.g., version and project details) that are in current deployment by the ETL server 135 and receive a selection of a particular ETL job, such as the ETL job received from the client and stored in the ETL job database in Block 410.

As a non-limiting example, a user's client computer or device 140 can request the ETL job optimizer tool 130 to scan the ETL job database 110 for a list of current ETL jobs and be provided a graphical user interface display 150 showing the list of current ETL jobs along with an option (e.g., selectable button or checkbox) to execute the ETL job optimization tool 130 and perform optimization(s)/improvement(s) for a selected one of the ETL jobs provided in the list.

In Block 430, ETL job metadata can be obtained using the retrieved or extracted information from block 420. For example, in various embodiments, the job extractor component 210 can obtain ETL job metadata and other details on the data source (e.g., input data & tables/records that are the subject of the ETL job), in Block 440. For example, the ETL job metadata for a particular job can contain information related to the input (source) tables used in the ETL job, the transformation nodes or the intermediate nodes used in the ETL job, the join nodes used, the filters used, the output table that is to be created, etc. Accordingly, a data source metadata parser component 220 can extract data source metadata from the data source database 120 using the input data sources provided by the job extractor component 210 and parsing the data source to obtain details/metadata on the input tables/sources used in the ETL job.

Next, in Block 450, the ETL job optimizer tool 130 can obtain database schema and additional metadata on the nodes and database tables that are referenced in data source metadata obtained by the data source metadata parser component 220 from Block 440. In various embodiments, the ETL job optimizer tool 130 can include a schema fetcher component 230 that executes a routine to obtain the database schema and related information that are referenced in the data source metadata obtained by the data source metadata parser component 220. For example, the schema and metadata information can indicate how/if the input tables are partitioned, clustered, or generally organized, etc. and may be contained within the data source database 120 or another database maintained on the computer network 115.

Then, in Block 460, a query parser component 240 of the ETL job optimizer tool 130 can parse the ETL job query and identify its structural components. In general, a database query follows a structure with core components that specify which data to retrieve, from which table, and under what conditions. Accordingly, in various embodiments, the query parser component 240 can parse the ETL job query into a tree like or hierarchal view of the structure with connected structural components comprising individual tables (e.g., partitioned tables, clustered tables, non-partitioned and/or clustered tables, etc.) and their connected nodes indicating the functions to be applied to such tables. Thus, the hierarchal view of the structure may represent information on the input tables, transformation steps, step definitions, actions within step definitions, etc. associated with a particular ETL job.

Thus, by examining the hierarchal structure built by the query parser component 240 along with the database table schema/metadata information obtained from the schema fetcher component 230, a recommender component 250 of the ETL job optimizer tool 130 can compile and recommend optimization actions for optimizing or correcting a particular ETL job.

In various embodiments, to compile the list of optimization actions, the recommender component 250 can perform a series of examinations to determine if the hierarchal structure contains particular issues that may need optimization or correcting. Such examinations may involve multiple steps and/or may be specified as types of rules that are performed by the recommender component 250.

For example, in certain embodiments, ETL jobs can be assessed by checking (1) appropriate use of a partition column, such as by (i) checking if a where clause is present; and if no, adding a recommendation to use a filter clause; (ii) checking if a filter clause is present; and if yes, checking for a partition column in a where clause; and if the partition column is not in a where clause; adding a recommendation to add a partitioned column to the filter clause; (iii) checking if a partition column exists; and if yes, sending an expression to the query parser component 240 to check if any function/casting is applied on the partition column; and/or (iv) checking if a casting/function is applied on the partition column; and if yes, then adding a recommendation to not apply the casting/function to the partitioned column; (2) appropriate use of a clustering column, such as by (i) checking if a where clause is present; and if no, adding a recommendation to use a filter clause; (ii) checking if a filter is present; and if no, then adding a recommendation to add clustered columns to the filter clause; (iii) checking if a filter is present; and if yes, checking for the ordering of the clustered columns, and add recommendation if ordering is not adhered; (iv) checking if clustered columns exist; and if yes, sending an expression to the query parser component 240 to check if any function/casting is applied on clustered columns; and/or (v) checking if a casting/function is applied to the clustering column; and if yes, adding a recommendation to not apply casting/function to clustered columns; (3) decryption to compare with Null, such as by (i) fetching a filter and selecting actions from step definitions; (ii) checking if a decryption function is applied in selected actions; (iii) if the decryption function is present, sending the expression to the query parser component 240; and/or (iv) adding a recommendation to not apply the decryption function when it is compared with Null as Null will remain Null post encryption/decryption; (4) optimized join patterns involving placing a table in a join operation with the largest number of rows first, followed by a table with the fewest rows and then placing the remaining tables by decreasing size (e.g., when you have a large table as the left side of the Join and a small one on the right side of the Join, a broadcast join is created. A broadcast join sends all the data in the smaller table to each slot that processes the larger table, which makes the join fast), such as by (i) fetching join actions; (ii) fetching tables used in Join; (iii) getting tables rows from schema information; and/or (iv) adding recommendation if the tables are not placed as per size basis; and/or (5) unused columns, such as by (i) fetching an ETL job; (ii) checking columns between a parent node and a child node within the hierarchal structure of the ETL job; and/or (iii) sending a recommendation for those columns which are present in the parent node but not in a child node.

Referring back to FIG. 4, in Block 470, the ETL job optimizer tool 130 can display one or more optimization recommendations (e.g., recommended optimization actions) for optimizing or correcting a particular ETL job. For example, in various embodiments, a recommender component 250 of the ETL job optimizer tool 130 can render a graphical user interface display 150 that contains a list of recommended optimization actions along with an option (e.g., button or checkbox) for a user to authorize all or individual ones of the recommended optimization actions to be performed by an applier component 260 of the ETL job optimizer tool 130.

Next, in Block 480, for various embodiments, the recommender component 250 of the ETL job optimizer tool can receive approval or authorization from a user's client 140 to perform one or more recommended optimization actions on a particular ETL job. In turn, the ETL job optimizer tool 130 can perform the one or more approved actions, in Block 490. For example, in various embodiments, the recommender component 250 can send instructions to the applier component 260 of the ETL job optimizer 130 to perform the one or more approved actions. Accordingly, after receiving authorization, the applier component 260 can modify the ETL job in accordance with the selected optimization actions and can replace the unoptimized ETL job in the ETL job database 110 with the optimized ETL job query and causes the optimized ETL job to be published so that the ETL job can be executed by the ETL server 135.

In various embodiments, the ETL job optimizer tool 130 can also include a roll back component 270, such that any optimization action corresponding to modifications made by the applier component 260 can be enabled to be undone or “rolled back” to a previous state that existed in the original unoptimized ETL job, as shown in Block 495, before any modifications were made by the ETL job optimizer tool 130. Accordingly for such embodiments, metadata can be saved on the changes made by the applier component 260 for selected optimization actions that can be referenced by the roll back component 270 to restore an ETL job or a portion of an ETL job to a previous state. Referring back to FIG. 4, in Block 499, after the optimized ETL job is placed in deployment on the ETL server 130, the ETL server can perform extraction, transformation, and loading operations in accordance with the optimized ETL job.

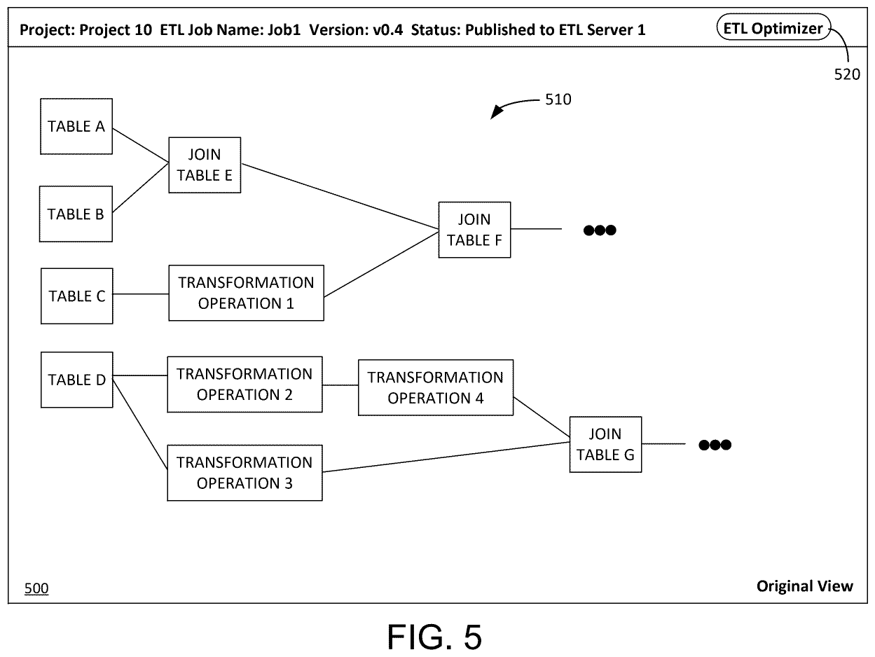

An exemplary graphical user interface 500 is depicted in FIG. 5. As depicted, the graphical user interface 500 displays an ETL job query into a tree like or hierarchal view of the structure 510 with connected structural elements comprising individual tables (e.g., Table A, Table B, etc.) and their connected nodes indicating the functions to be applied to such tables, such as Join and Transformation operations. Thus, a particular transformation operation (e.g., Transformation Operation 2) may be a cast function that is to be applied to a particular table (e.g., Table D). Accordingly, by examining the hierarchal structure of an ETL job, the ETL job optimizer tool 130 can compile and recommend optimization actions to a user in a graphical user interface display 150. As such, in various embodiments, a graphical control (e.g., a selectable button) 520 is provided for a user to activate and request the ETL job optimizer tool 130 to perform optimization(s)/improvement(s) to the displayed ETL job structure 510. In this figure and the following figures, ellipses (“. . . ”) are shown to indicate that the displayed content may extend or include additional content similar to that expressly displayed in the figures.

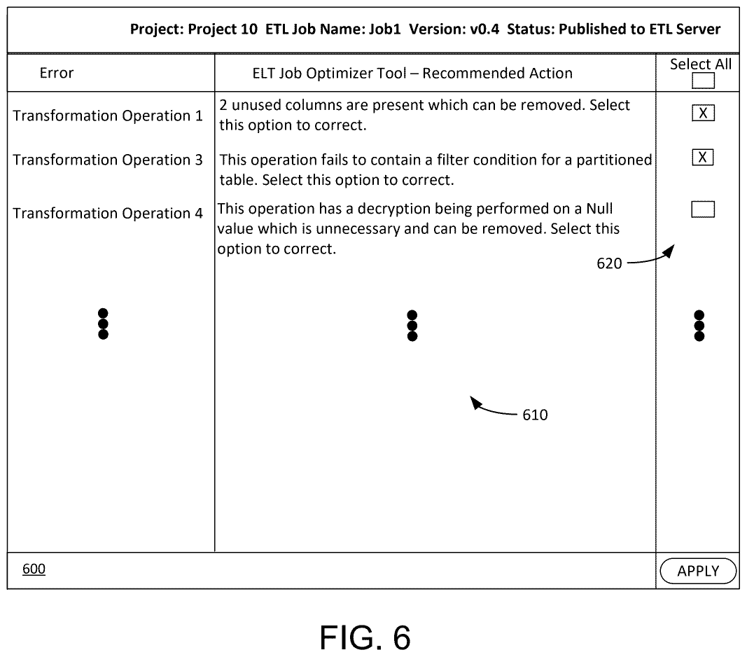

Accordingly, as shown in FIG. 6, in various embodiments, an exemplary graphical user interface display 600 is provided by the ETL server 135 that contains a list of recommended optimization actions along with an option (e.g., button or checkbox) for a user to authorize all or individual ones of the recommended optimization actions to be performed by an applier component 260 of the ETL job optimizer tool 130. Thus, in various embodiments, the ETL server 135 presents a graphical user interface display 600 that delineates the aspects of the ETL job that can be optimized or improved and details on how the ETL job can be modified to result in the improvement (e.g., in Transformation Operation 1, “2 unused columns are present which can be removed.”). In the example, shown in FIG. 6, particular transformation operations having error(s) detected by the ETL job optimizer tool 130 are shown in a list with an explanation of the error and the suggested course of action (recommended optimization action) to correct the error. By selecting a checkbox next to individual ones of the recommended actions and activating a designated graphical control (e.g., Apply Button 630), the ETL job optimizer tool 130 of the ETL server 135 is then authorized to proceed with performing the selected action.

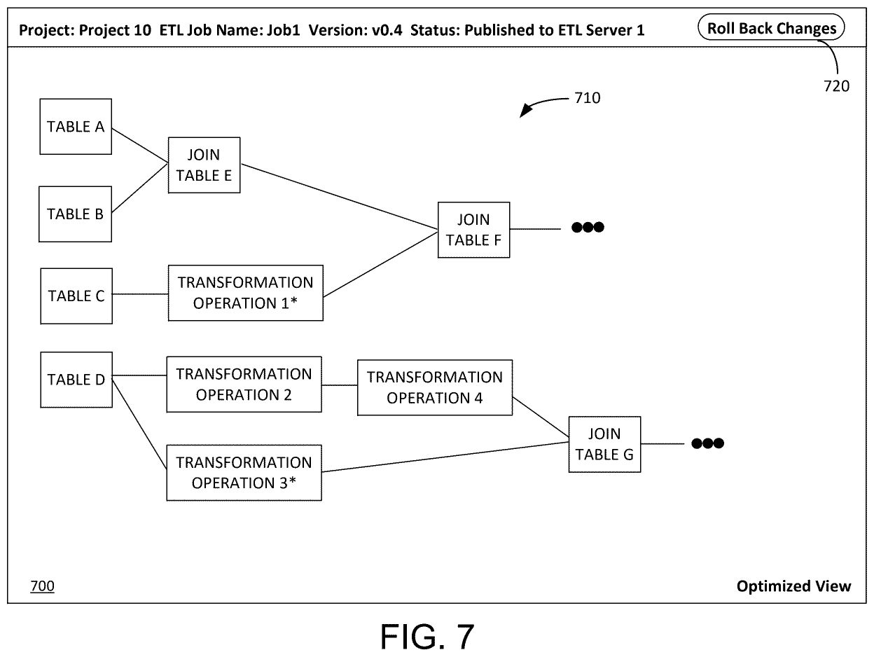

Next, as shown in FIG. 7, in various embodiments, an exemplary graphical user interface display 700 is provided by the ETL server 135 that presents an optimized view of the ETL job (of FIG. 5) that is corrected by the ETL job optimizer tool 130. Accordingly, a graphical user interface 700 displays the optimized ETL job query into a tree like or hierarchal view of the structure 710 with connected structural elements comprising individual tables (e.g., Table A, Table B, etc.) and their connected nodes indicating the functions to be applied to such tables, such as Join and Transformation operations. In the optimized view, transformation operations (e.g., Transformation Operation 1* in FIG. 7) that have been corrected or modified are shown in place of the original transformation operation (e.g., Transformation Operation 1 in FIG. 5). Thus, a particular transformation operation (e.g., Transformation Operation 1) in FIG. 5 may have originally had 2 unused columns, that were recommended to be removed in FIG. 6, and replaced with an optimized transformation operation (e.g., Transformation Operation 1* that has the 2 unused columns removed) in FIG. 7.

In various embodiments, the graphical user interface 700 may also include a graphical control (e.g., selectable button or checkbox) that can be activated to execute a roll back component 270 of the ETL job optimizer tool 130, such that any optimization actions corresponding to modifications made by the applier component 260 of the ETL job optimizer tool 130 can be undone or “rolled back” to a previous state that existed in the original unoptimized ETL job (shown in FIG. 5). Accordingly, for such embodiments, metadata is saved on the changes made by the applier component 260 for selected optimization actions that can be referenced by the roll back component 270 to restore an ETL job or a portion of an ETL job to a previous state.

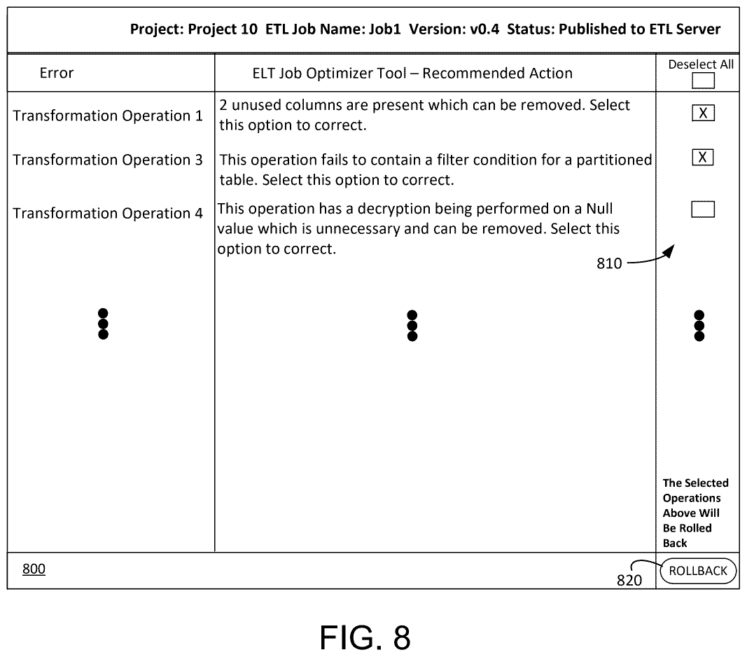

In various embodiments, activation of the Roll Back Changes button 270 may cause all of the initially selected options (in FIG. 6) to be rolled back or changed to their previous states. Alternatively, activation of the Roll Back Changes button 270 may cause a graphical user interface 800 (FIG. 8) to be displayed that contains the list of recommended optimization actions along with the initial options (e.g., button or checkbox) selected by the user to be performed by an applier component 260 of the ETL job optimizer tool 130. Thus, in various embodiments, the ETL server 135 presents a graphical user interface display 800 that shows the aspects of the ETL job that were previously selected 810 by the user (e.g., checkbox may be filled or populated with an X). In this example, the user can now decide which ones of the previously selected operations are to be rolled back to a previous state. In various embodiments, the selection of a filled checkbox next to individual ones of the recommended actions will cause the checkbox to become unfilled (deselected), such that the deselected operations will not be included in a Roll Back operation after selecting/activating a Rollback button or graphical control 820 (FIG. 8).

The present disclosure provide one or more novel and improved aspects for ETL systems, methods, and/or computer-readable storage mediums. In various embodiments, such systems, methods, and/or computer-readable storage mediums involve receiving an extraction, transformation, and loading (ETL) job that is in current deployment on an ETL job database; obtaining ETL job metadata for the extracted ETL job; obtaining database schema for data sources in the ETL job; using the database schema, parsing the ETL job to identify structural components of the ETL job; providing, in a graphical user interface display, one or more recommendations to perform one or more optimization actions to correct at least one error present in at least one structural component of the ETL job; and/or performing the one or more optimization actions to correct the at least one error present in the at least one structural components of the ETL job.

Accordingly, systems, methods, and/or computer-readable storage mediums of the present disclosure improve the operation of ETL systems and the structure of ETL job queries by examining and correcting for structural defects within ETL job queries, thereby enabling enhanced performance and resource utilization of ETL systems and methods for processing big data sets in a distributed computing environment. For example, optimized ETL systems and processes lead to faster processing of ETL jobs which decreases the lag time between a response and a request and improves the quality of information provided to users and their customers or other third parties. Accordingly, in today's dynamic business landscape, where timely insights are crucial for informed decision making, optimizing ETL jobs becomes imperative. Efficiently optimized ETL processes ensure that data is processed swiftly and accurately, enabling organizations to derive actionable insights promptly and maintain a competitive edge.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface, a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet account), a communications port, a Personal Computer Memory Account International Association (PCMCIA) slot and account, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s). As such, certain embodiments of the present disclosure can be implemented in hardware, software, firmware, or a combination thereof. If implemented in hardware, certain embodiments can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The various system components may be independently, separately or collectively suitably coupled to the network via data links which includes, for example, a connection to an Internet Service Provider (ISP) over the local loop as is typically used in connection with standard modem communication, cable modem, fiber optic networks, ISDN, Digital Subscriber Line (DSL), or various wireless communication methods, which is hereby incorporated by reference. It is noted that the network may be implemented as other types of networks, such as satellite networks, cellular networks, an interactive television (ITV) network.

Any databases discussed herein may include relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computers discussed herein may provide a suitable website or other Internet-based graphical user interface which is accessible by users. Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® Applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address. The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like.

Any process descriptions or blocks in flow charts should be understood as representing modules, segments, or portions of code which include one or more executable instructions for implementing specific logical functions in the process, and alternate implementations are included within the scope of various embodiments of the present disclosure in which functions may be executed out of order from that shown or discussed, including substantially concurrently or in reverse order, depending on the functionality involved, as would be understood by those reasonably skilled in the art of the present disclosure. It will be understood that each functional block of the block diagrams and the flowchart illustrations of the present disclosure, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

It should be emphasized that the above-described embodiments of the are merely possible examples of implementations, merely set forth for a clear understanding of the principles of the present disclosure. Many variations and modifications may be made to the above-described embodiment(s) without departing substantially from the spirit and principles of the invention. All such modifications and variations are intended to be included herein within the scope of this disclosure.

1. A system, comprising:
a computing device comprising a processor and a memory; and
machine-readable instructions stored in the memory that, when executed by the processor, cause the computing device to at least:
receive an extraction, transformation, and loading (ETL) job that is in current deployment on an ETL job database;
obtain ETL job metadata for the extracted ETL job;
obtain database schema for input data sources in the ETL job;
using the database schema, parse the ETL job into a hierarchal structure, wherein the hierarchal structure identifies structural components of the ETL job and a plurality of connected nodes of the hierarchal structure represents functions being applied to the structural components of the ETL job;
provide, in a graphical user interface display, one or more recommendations to perform one or more optimization actions for at least one structural component of the ETL job based at least in part on examination of the hierarchal structure; and
perform the one or more optimization actions for the at least one structural component of the ETL job.

2. The system of claim 1, wherein the computing device is further caused to parse the ETL job metadata to identify an input data source for the ETL job, wherein the input data source is used to obtain the database schema for the input data sources.

3. The system of claim 1, wherein the computing device is further caused to provide, in the graphical user interface display, an option to roll back the one or more optimization actions that have been performed to an earlier state.

4. The system of claim 1, wherein the computing device is further caused to perform the ETL job after the one or more optimization actions are completed.

5. The system of claim 1, wherein the one or more optimization actions correct one or more unused columns in a data table, a join operation being applied in an incorrect order, an unnecessary decryption operation, clustering columns usage, or partition column usage, wherein the input data sources comprise the data table.

6. The system of claim 1, wherein the computing device is further caused to provide, in the graphical user interface display, a first hierarchal view of the ETL job before the one or more optimization actions are performed and a second hierarchal view of the ETL job after the one or more optimization actions are performed.

7. The system of claim 1, wherein, in the graphical user interface display, a graphical control is provided to individually select the one or more optimizations actions that are to be performed for at least one structural component of the ETL job.

8. A method performed by a computing device, comprising:
receiving an extraction, transformation, and loading (ETL) job that is in current deployment on an ETL job database;
obtaining ETL job metadata for the extracted ETL job;
obtaining database schema for input data sources in the ETL job;
using the database schema, parsing the ETL job into a hierarchal structure, wherein the hierarchal structure identifies structural components of the ETL job and a plurality of connected nodes of the hierarchal structure represents functions being applied to the structural components of the ETL job;
providing, in a graphical user interface display, one or more recommendations to perform one or more optimization actions for at least one structural component of the ETL job based at least in part on examination of the hierarchal structure; and
performing the one or more optimization actions for the at least one structural component of the ETL job.

9. The method of claim 8, further comprising parsing the ETL job metadata to identify an input data source for the ETL job, wherein the input data source is used to obtain the database schema for the input data sources.

10. The method of claim 8, further comprising providing an option in the graphical user interface display to roll back the one or more optimization actions that have been performed to an earlier state.

11. The method of claim 8, further comprising performing the ETL job after the one or more optimization actions are completed.

12. The method of claim 8, wherein the one or more optimization actions correct one or more unused columns in a data table, a join operation being applied in an incorrect order, an unnecessary decryption operation, clustering columns usage, or partition column usage, wherein the input data sources comprise the data table.

13. The method of claim 8, further comprising providing, in the graphical user interface display, a first hierarchal view of the ETL job before the one or more optimization actions are performed and a second hierarchal view of the ETL job after the one or more optimization actions are performed.

14. The method of claim 8, wherein, in the graphical user interface display, a graphical control is provided to individually select the one or more optimizations actions that are to be performed for at least one structural component of the ETL job.

15. A non-transitory, computer-readable medium comprising machine-readable instructions that, when executed by a processor of a computing device, cause the computing device to at least:
receive an extraction, transformation, and loading (ETL) job that is in current deployment on an ETL job database;
obtain ETL job metadata for the extracted ETL job;
obtain database schema for input data sources in the ETL job;
using the database schema, parse the ETL job into a hierarchal structure, wherein the hierarchal structure identifies structural components of the ETL job and a plurality of connected nodes of the hierarchal structure represents functions being applied to the structural components of the ETL job;
provide, in a graphical user interface display, one or more recommendations to perform one or more optimization actions for at least one structural component of the ETL job based at least in part on examination of the hierarchal structure; and
perform the one or more optimization actions the at least one structural component of the ETL job.

16. The non-transitory, computer-readable medium of claim 15, wherein the computing device is further caused to parse the ETL job metadata to identify an input data source for the ETL job, wherein the input data source is used to obtain the database schema for the input data sources.

17. The non-transitory, computer-readable medium of claim 15, wherein the computing device is further caused to provide, in the graphical user interface display, an option to roll back the one or more optimization actions that have been performed to an earlier state.

18. The non-transitory, computer-readable medium of claim 15, wherein the computing device is further caused to perform the ETL job after the one or more optimization actions are completed.

19. The non-transitory, computer-readable medium of claim 15, wherein the one or more optimization actions correct one or more unused columns in a data table, a join operation being applied in an incorrect order, an unnecessary decryption operation, clustering columns usage, or partition column usage, wherein the input data sources comprise the data table.

20. The non-transitory, computer-readable medium of claim 15, wherein the computing device is further caused to provide, in the graphical user interface display, a first hierarchal view of the ETL job before the one or more optimization actions are performed and a second hierarchal view of the ETL job after the one or more optimization actions are performed.
